(19) United States
(12) Patent Application Publication
(10) Pub. No.: US 2023/0140706 A1
(43) Pub. Date: May 4, 2023

(54) Pipelined Malware Infrastructure Identification

(71) Applicant: Recorded Future, Inc., Somerville, MA (US)

(72) Inventors: Bill Ladd, Watertown, MA (US); Levi Gundert, El Cajon, CA (US); Chas Tomlin, Southampton (GB)

(21) Appl. No.: 17/516,046

(22) Filed: Nov. 1, 2021

(51) Int. Cl. G06F 21/56; G06F 21/53

(52) U.S. Cl. CPC G06F 21/56; G06F 21/53; G06F 2221/034

(57) ABSTRACT

Disclosed, in one general aspect, is a network security system that includes pipeline storage operative to receive a series of malware samples. A sandboxed operating environment is responsive to the pipeline storage and operative to automatically retrieve successive malware samples from the pipeline storage, to run each of the malware samples in the sandboxed operating environment after it is retrieved, and to analyze at least some communication from each of the malware samples as they are run. A verdict output is responsive to the sandboxed operating environment to provide a verdict for malicious internet infrastructure associated with at least some of the malware samples run in the sandboxed operating environment.

### FIELD OF THE INVENTION

This invention relates to methods and apparatus for evaluating security and/or protecting systems on large computer networks, such as the Internet.

### BACKGROUND OF THE INVENTION

Administrators of large private networks, such as corporate or governmental networks, need to take steps to secure them from various types of attacks. Command-and-Control (C2) servers on the internet are important to identify because, if an organization has infected computers, they may try to communicate to external command and control machines operated by threat actors. If organizations can identity Internet Protocol (IP) addresses and domains associated with C2 servers, they can block that traffic at their firewall and mitigate the risk of infection.

Malware sandboxing is a process where malware is allowed to execute in a monitored environment and controlled environment. Network connections (IPs and domains) made or attempted by malware are then observed. These network connections are however generally not sufficient to deliver a verdict on whether the IP addresses and domains are malicious.

### SUMMARY OF THE INVENTION

In one general aspect, the invention features a network security system that includes pipeline storage operative to receive a series of malware samples. A sandboxed operating environment is responsive to the pipeline storage and operative to automatically retrieve successive malware samples from the pipeline storage, to run each of the malware samples in the sandboxed operating environment after it is retrieved, and to analyze at least some communication from each of the malware samples as they are run. A verdict output is responsive to the sandboxed operating environment to provide a verdict for malicious internet infrastructure associated with at least some of the malware samples run in the sandboxed operating environment.

In preferred embodiments, the system can further include an automatic file analysis tool operative to successively compare at least parts of each of the malware samples with patterns corresponding to known malware types, with the verdict output being a combined verdict output responsive both to the traffic analysis tool and to the file analysis tool to provide a compound verdict for each of the malware samples run in the sandboxed operating environment based on results from both the network traffic analysis tool and the file analysis tool. The system can further include verdict database storage operative to store the verdicts as they are output. The system can further include command-and-control server probing logic operative to probe suspected command-and-control servers for the malware samples on an external network. The system can further include candidate command-and-control server generation logic operative to generate candidate addresses for probing by the command-and-control server probing logic. The candidate command-and-control server generation logic can generate candidate addresses based on shared domain mappings. The pipeline storage can be responsive to malware providers and Internet repositories. The network security system can be operative to automatically process at least thousands, tens of thousands, or even hundreds of thousands of malware samples per day. The verdict output can be operative to provide a verdict for malware infrastructure associated with IP addresses. The verdict output can be operative to provide a verdict for malware infrastructure associated with Internet domains. The verdict output can be operative to provide a verdict for command-and-control servers.

In another general aspect, the invention features a network security method that includes receiving a series of malware samples for processing, automatically retrieving successive ones of the received malware samples to successively run each of the malware sample in the sandboxed operating environment, automatically analyzing at least some network communication from each of the malware samples as they are run in the sandboxed operating environment, and providing a verdict for malware infrastructure associated with at least some of the malware samples run in the sandboxed operating environment based on results from the automatic network communication analysis.

In a further general aspect, the invention features a network security system that includes means for receiving a series of malware samples for processing, means for automatically retrieving successive ones of the received malware samples to successively run each of the malware samples in the sandboxed operating environment, means for automatically analyzing at least some network communication from each of the malware samples as they are run in the sandboxed operating environment, and means for providing a verdict for malware infrastructure associated with at least some of the malware samples run in the sandboxed operating environment based on results from the automatic network communication analysis.

Systems according to the invention can help network administrators to detect, understand, and remedy risks posed by malware that communicates with command-and-control servers or other types of attack infrastructure.

### BRIEF DESCRIPTION OF THE DRAWING

FIG. 1 is a block diagram of an illustrative network security system according to the invention; and;

FIG. 2 is a flowchart illustrating the operation of the system of FIG. 1.

### DETAILED DESCRIPTION OF AN ILLUSTRATIVE EMBODIMENT

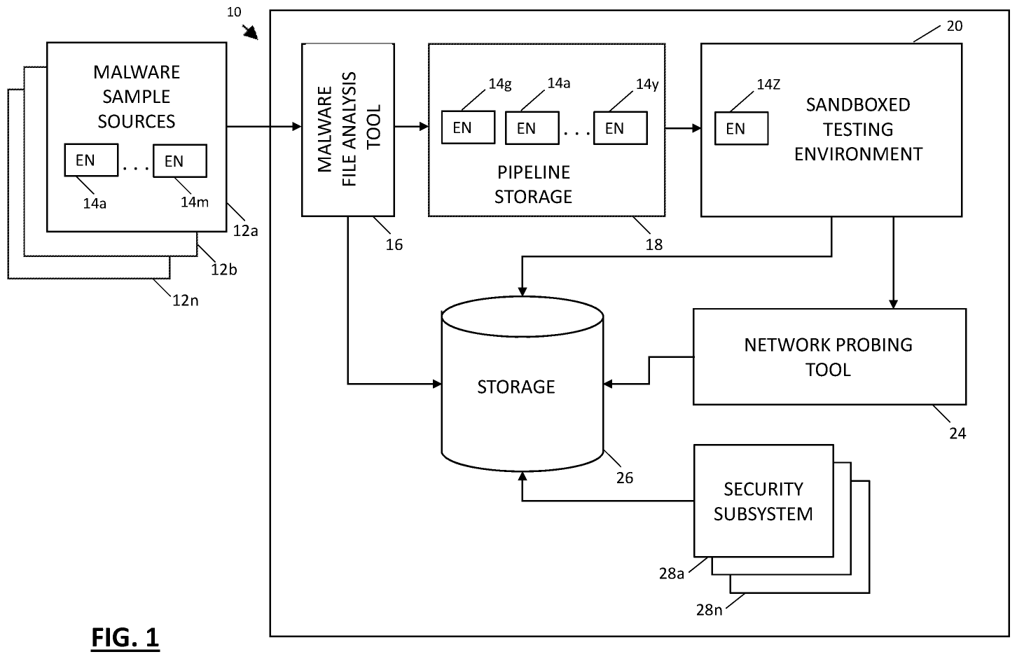

Referring to FIG. 1, a network security system 10 includes an input for receiving malware samples 14n . . . 14m from one or more internal or third-party sources 12a . . . 12n. The input is connected to an automated malware file analysis tool 16 that detects characteristics of the received malware samples. In one embodiment, this tool can employ YARA, which is a tool that uses rules to detect patterns in a sample file. YARA was originally developed by Victor Alvarez of VirusTotal, and Release 4.1.0 of the YARA documentation is herein incorporated by reference.

The malware analysis tool 16 relays the samples to be queued for further processing in pipeline storage 18 on an ongoing basis. Each sample is then in turn run in a sandboxed testing environment 20 where its behavior is observed. The sandboxed testing environment can use the Suricata system, which is a Network IDS, IPS, and Network Security Monitoring engine developed by the Open Information Security Foundation (OISF). Release 6.0.3 of the Suricata user guide is herein incorporated by reference. The pipeline storage can preferably store a backlog of malware samples so that they are ready to be processed to achieve a high overall throughput, but it may also be possible for the pipeline storage to simply relay malware samples as they are received.

The network security system 10 also includes a network probing tool 24. This tool is connected to a network, such as the Internet, to probe for C2 servers. Supervisory sequencing logic automatically controls the different parts of the system to allow it to operate automatically and process samples on an ongoing basis.

The network security system 10 is preferably implemented as part of a larger system that also includes other security subsystems 28. These systems can share at least some common storage 30, such as a database, to store addresses and other types of threat data. In one embodiment, the security monitoring system includes features of the Recorded Future Temporal Analytics Engine, which is described in more detail in U.S. Pat. No. 8,468,153 entitled INFORMATION SERVICE FOR FACTS EXTRACTED FROM DIFFERING SOURCES ON A WIDE AREA NETWORK and in U.S. Publication No. 20180063170 entitled NETWORK SECURITY SCORING. Related technology is also discussed in the paper entitled “Proactive Threat Identification Neutralizes Remote Access Trojan Efficiency,” by Levi Gundert (2016) and in the application entitled MALWARE VICTIM IDENTIFICATION, docket number A0007-025001, filed on the same date as this application. The documents referenced in this paragraph are all herein incorporated by reference.

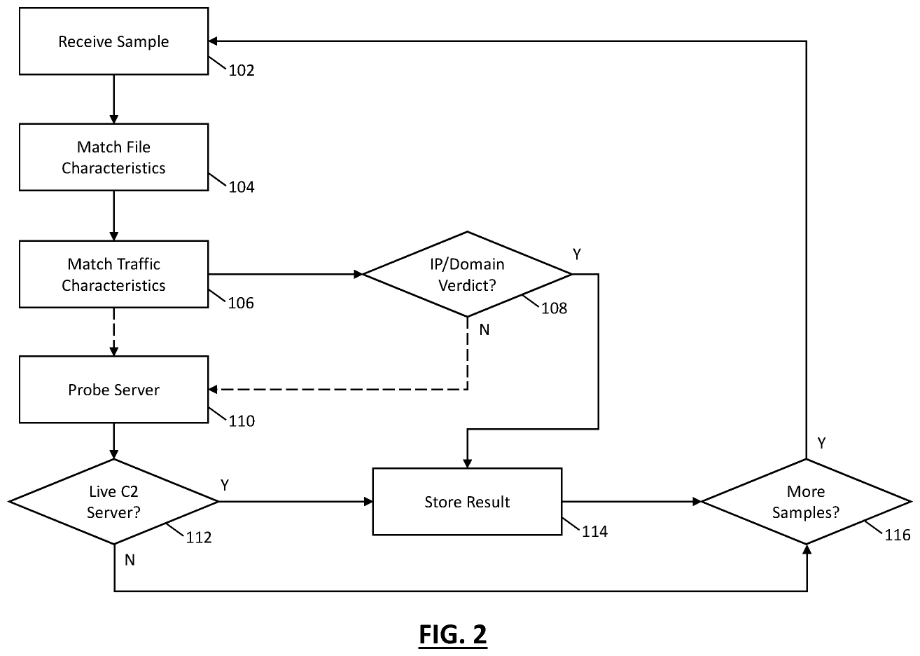

Referring also to FIG. 2, in operation, the security system 10 first receives a malware sample file (step 102). The malware file analysis tool 16 attempts to match characteristics of the received sample file to known malware (step 104). And the sandboxed operating environment 20 then attempts to match characteristics of traffic from the sample as it is run (step 106). These two tests taken together can generally allow the system to issue a verdict for an IP or domain (step 108). If so, a result record for the IP or domain can be stored (step 114). The process can then be repeated automatically for a series of sample files on an ongoing basis (step 116).

The network probing tool can also probe the network to determine if a suspected C2 server for the sample is live. This process can be repeated with candidate C2 addresses derived from verified C2s. These candidate addresses are similar but not the same as the verified addresses. They may share domain mappings, for example. Probing of these candidate addresses can allow a verdict to be issued on additional addresses, and these can be added to the storage.

Because the security system 10 can operate automatically, samples from malware providers, Internet repositories and other sources can be processed at high throughput rates, and extensive maps of C2 servers can be built in real time. These maps can be an important resource in protecting networks against malware and in detecting and remediating network breaches. In one embodiment, the system is capable of processing tens or even hundreds of thousands of samples per day.

The system described above has been implemented in connection with digital logic, storage, and other elements embodied in special-purpose software running on a general-purpose computer platform, but it could also be implemented in whole or in part using virtualized platforms and/or special-purpose hardware. And while the system can be broken into the series of modules and steps shown in the various figures for illustration purposes, one of ordinary skill in the art would recognize that it is also possible to combine them and/or split them differently to achieve a different breakdown.

The embodiments presented above can benefit from temporal and linguistic processing and risk scoring approaches outlined in US Patent Publication No. 2020-0401961 entitled CROSS-NETWORK SECURITY EVALUATION, published Feb. 11, 2021 and US Patent Publication No. 2021-0042409 entitled AUTOMATED ORGANIZATIONAL SECURITY SCORING SYSTEM, published Dec. 24, 2020 and the documents they refer to. The documents referenced directly and indirectly in this paragraph are all herein incorporated by reference.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A network security system, comprising:
pipeline storage operative to receive a series of malware samples,
a sandboxed operating environment responsive to the pipeline storage and operative to automatically retrieve successive malware samples from the pipeline storage, to run each of the malware samples in the sandboxed operating environment after it is retrieved, and to analyze at least some communication from each of the malware samples as they are run, and
a verdict output responsive to the sandboxed operating environment to provide a verdict for malicious internet infrastructure associated with at least some of the malware samples run in the sandboxed operating environment.

2. The system of claim 1 further including an automatic file analysis tool operative to successively compare at least parts of each of the malware samples with patterns corresponding to known malware types, and wherein the verdict output is a combined verdict output responsive both to the traffic analysis tool and to the file analysis tool to provide a compound verdict for each of the malware samples run in the sandboxed operating environment based on results from both the network traffic analysis tool and the file analysis tool.

3. The system of claim 1 further including verdict database storage operative to store the verdicts as they are output.

4. The system of claim 1 further including command-and-control server probing logic operative to probe suspected command-and-control servers for the malware samples on an external network.

5. The system of claim 3 further including candidate command-and-control server generation logic operative to generate candidate addresses for probing by the command-and-control server probing logic.

6. The system of claim 4 wherein the candidate command-and-control server generation logic generates candidate addresses based on shared domain mappings.

7. The system of claim 1 wherein the pipeline storage is responsive to malware providers and Internet repositories.

8. The system of claim 1 wherein the network security system is operative to automatically process at least thousands of malware samples per day.

9. The system of claim 1 wherein the network security system is operative to automatically process at least tens of thousands of malware samples per day.

10. The system of claim 1 wherein the network security system is operative to automatically process at least hundreds of thousands of malware samples per day.

11. The system of claim 1 wherein the verdict output is operative to provide a verdict for malware infrastructure associated with IP addresses.

12. The system of claim 1 wherein the verdict output is operative to provide a verdict for malware infrastructure associated with Internet domains.

13. The system of claim 1 wherein the verdict output is operative to provide a verdict for command-and-control servers.

14. A network security method, comprising:
receiving a series of malware samples for processing,
automatically retrieving successive ones of the received malware samples to successively run each of the malware sample in the sandboxed operating environment,
automatically analyzing at least some network communication from each of the malware samples as they are run in the sandboxed operating environment, and
providing a verdict for malware infrastructure associated with at least some of the malware samples run in the sandboxed operating environment based on results from the automatic network communication analysis.

15. A network security system, comprising:
means for receiving a series of malware samples for processing,
means for automatically retrieving successive ones of the received malware samples to successively run each of the malware samples in the sandboxed operating environment,
means for automatically analyzing at least some network communication from each of the malware samples as they are run in the sandboxed operating environment, and
means for providing a verdict for malware infrastructure associated with at least some of the malware samples run in the sandboxed operating environment based on results from the automatic network communication analysis.
